(19) United States
(12) Patent Application Publication
(10) Pub. No.: US 2004/0109430 A1
(43) Pub. Date: Jun. 10, 2004

(54) Low cost implementation for high performance embedded systems

(76) Inventors: Francis daCosta, San Jose, CA (US); Sriram Dayanandan, San Jose, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/641,917

(22) Filed: Aug. 15, 2003

Related U.S. Application Data
(63) Continuation-in-part of application No. 10/434,948, filed on May 8, 2003.
(60) Provisional application No. 60/421,930, filed on Oct. 28, 2002.

(51) Int. Cl. H04Q 7/24

(52) U.S. Cl. 370/338

(57) ABSTRACT

Based on the two types of an analysis of programs at the Byte code Level, a co-development framework for low cost embedded system development is described that eliminates dependencies and licensing costs of an OS, JVM and, in many cases, processor cores. One embodiment of the present invention is integrated into an open Java based development environment (IBM's Eclipse) and supports:

OS Stack-Less C code Executable creation based on Soft Chips approach. Java byte code is analyzed and a low footprint self-standing C code is created, with essential services required by the application fused with it. It eliminates the overhead/licensing of an OS/JVM for Embedded Java apps. It enables the use of lower cost and lower power 8/16 bit microprocessors.

Processor-Less Verilog “code” creation. This is a Java—FPGA/ASIC conversion tool analyses Java byte code to automatically create a customized co-processor to process the Java Byte code of the application. Both the application byte code and required co-processor are converted to a Verilog file for FPGA/ASIC creation, resulting in a high performance, low power compact module. It enables the use of lower cost and lower power 8/16 bit microprocessors. In many applications, it eliminates the need and associated costs for a general-purpose processor.

### CROSS-REFERENCE

This application claims the benefit of priority from U.S. Provisional Application No. 60/421,930, filed Oct. 28, 2002, and is a continuation-in-part of application of U.S. application Ser. No. 10/434,948, filed May 8, 2003, which are herein incorporated by reference.

### FIELD OF THE INVENTION

The present application describes further enhancements to the implementation of the algorithms in hardware described in the previous application. In the referenced patent application, a method to reduce the software footprint was described, employing a method by which a self standing small footprint executable was produced by analyzing Java application code at the byte code level. On analysis, a method to identify components of the Operating System that were needed to run the application was described. Including only those portions of the Operating System services that were essential to the application resulted in a low footprint executable that could run on lower cost microprocessors. The approach was described as the Application Specific Operating System (ASOS).

The invention addressed in this document relates to how further cost reductions and performance improvements are achieved based also on further analysis of the Java program at the byte code level to generate a hardware specification for a Field Programmable Gate Array (FPGA) or an Application Specific Integrated Circuit (ASIC) implementation in a Hardware Description Language (HDL) such as Verilog. By doing so, the requirements on the speed or power (and associated cost) of the processor are further reduced.

Additionally, a method is described to enable the creation, dynamically and automatically, of the “circuit” for a custom Java processor to run the Java code being converted to hardware. This enables the Java code running in hardware to run with its own processor in hardware, thereby further reducing the load on the embedded system microprocessor—and in some cases eliminating the need for one altogether.

### BACKGROUND OF THE INVENTION

With today's complex systems and high-performance silicon, the worlds of hardware and software engineering are converging fast. Traditional processor based solutions start with a high-level design, which is partitioned into hard and soft components.

For hardware engineers, taking complex functions and describing them in HDL (Hardware Description Language) to produce a high-performance field programmable gate array (FPGA) or application-specific integrated circuit (ASIC) design can be extremely challenging and time consuming. For software engineers, these same functions are relatively simple to implement in code that can easily be integrated with the overall system. However, the sequential nature of processors and their reliance on high clock speeds to perform fast calculations often impose limits on performance.

The ideal would be a middle ground, with the performance advantages of parallelism gained through hardware. A few years ago this would have been a pipe dream but advances in software tools and the growing functionality and capability of field-programmable devices now enable software concepts to be implemented on hardware, without getting involved in a time—consuming and costly HDL design loop.

By using modern, multimillion gate Field Programmable Gate Array (FPGA) technology, software components can be realized in silicon faster than traditional methods, enhancing the time-to-market opportunities. What is more, such solutions can extend the lifetime of hardware, as new functions or efficiencies can simply be re-programmed on devices out in the field. Programmable gate arrays can even be modified over the Internet.

Means to generate HDL from Java source code (as opposed to Java Byte Code) exist. However, the code blocks created do not support all the functionality that the Java programming language supports. Further, there is no provision to support recursion and stack operations since the HDL so generated is primarily a function block with all processing handled by the software running on the processor.

The challenge lies in providing—within the same FPGA—the ability to both generate the HDL from Byte Code Level (to avoid issues with source code exposure) and, at the same time to generate a custom Java processor to run the application code. This enables a more cost effective utilization of the FPGA or ASICS, since the chip now contains within it both the application and the engine to run the application. Portions of the application can now be converted to hardware (FPGAs, ASICs) to get high performance since both the application logic and the custom processor engine are in hardware. Also, in the case of an FPGA both the application and its custom processor can be downloaded from the web, which also allows for remote re-programmability.

### SUMMARY OF THE INVENTION

Accordingly, there is a need for, and an objective of the present invention, to develop a comprehensive software driven approach to embedded systems development which enables software programmers writing code in a high level language like Java, to generate “hard” chips- conversion of Java code by analysis of the byte code to generate in a Hardware Description Language (HDL) both the logic of the Java application code block and a custom, application specific Java processor generated at design time to run the Java application code.

This invention focuses on the creation of “hard” chips generated from Java byte code and that include the custom, application specific processor to run the code. In contrast, the “soft” chip approach focused on generating the application specific and small footprint software for embedded system processors and has been described in the previous patent application, herein incorporated by reference.

Together, both approaches, (hard and soft) supported in one Java based development framework (e.g. Eclipse), form a complete co-design framework for embedded system development that includes all variations between “soft” and “hard”. The entire application may be written in Java, tested in a Java Development Environment and then converted to run either entirely on a general purpose commercially available microprocessor or run entirely within an FPGA/ASIC with the custom processor generated for the application. Further, since all source code for both deployments is Java, it is possible to start with all software running on a processor and gradually shift over portions towards an FPGA/ASIC deployment.

This invention thus provides within one Java based development framework and one code base, a migration strategy between software and hardware deployments, driven by volumes and price/performance metrics. Benefits of this approach include:

1. One code base in a high level programming language (e.g. Java). Both hardware and software based deployment vehicles with the same code base in Java. Hardware and software programming languages and frameworks have typically been different and not interchangeable.

2. Deployment vehicles operate at a byte code level. No access to source code required, thereby protecting access to intellectual property.

3. Approach allows product life cycle support. Low volumes predicate a “soft” approach, as volumes increase portions of the code base may be automatically converted from “soft” to “hard” with minimal additional development costs.

4. “Hard” chip approach includes the ability to generate the custom processor for the ASIC/FPGA, thereby reducing the dependency and licensing costs of microprocessor cores and also resulting in a higher performance system.

These and other embodiments of the present invention are further made apparent, in the remainder of the present document, to those of ordinary skill in the art.

### BRIEF DESCRIPTION OF DRAWINGS

In order to more fully describe embodiments of the present invention, reference is made to the accompanying drawings. These drawings are not to be considered limitations in the scope of the invention, but are merely illustrative.

FIGS. 1, 2, 3 illustrate the conversion of Java Byte Code instructions to a more uniform format based on RISC (Reduced Instruction Set Computing) concepts, according to an embodiment of the present invention

FIG. 4 illustrates the high level process architecture of the Java custom processor, according to an embodiment of the present invention

FIG. 5 shows how the structure of run time objects in Java that is implemented within the memory structure of the custom processors is handled, according to an embodiment of the present invention

FIG. 6 indicates how a special type of run time object, an array, is handled with pointers to other run time objects, according to an embodiment of the present invention

FIG. 7 illustrates the frame stack needed to manage recursion and subroutine calls from within a program, according to an embodiment of the present invention

FIG. 8 illustrates the ASM chart for generating the equivalent of Java Byte Code instructions, AALOAD, IALOAD, FALOAD, BALOAD, CALOAD, according to an embodiment of the present invention

FIG. 9 illustrates the ASM chart for generating the equivalent of Java Byte Code instructions, DALOAD, LALOAD, SALOAD, according to an embodiment of the present invention.

FIG. 10 illustrates the ASM chart for generating the equivalent of Java Byte Code instructions for AASTORE, IASTORE, FASTORE, BASTORE, CASTORE, according to an embodiment of the present invention.

FIG. 11 illustrates the ASM chart for generating the equivalent of Java Byte Code instructions for DASTORE. LASTORE, SASTORE, according to an embodiment of the present invention.

FIG. 12 illustrates the ASM chart for generating the equivalent of Java Byte Code instructions for ACONST, DCONST, LCONST, according to an embodiment of the present invention.

FIG. 13 illustrates the ASM chart for generating the equivalent of Java Byte Code instructions for ICONST, according to an embodiment of the present invention.

FIG. 14 illustrates the ASM chart for generating the equivalent of Java Byte Code instructions for FCONST, BIPUSH, SIPUSH, according to an embodiment of the present invention.

FIG. 15 illustrates the ASM chart for generating the equivalent of Java Byte Code instructions for ALOAD, DLOAD, ASTORE, according to an embodiment of the present invention

FIG. 16 illustrates the ASM chart for generating the equivalent of Java Byte Code instructions for DSTORE, D2F, D21, according to an embodiment of the present invention

FIG. 17 illustrates the ASM chart for generating the equivalent of Java Byte Code instructions for D2L F2D, F21, according to an embodiment of the present invention

FIG. 18 illustrates the Run time architecture of the board integrated with the development framework to test portions of the Java to hardware conversion, according to an embodiment of the present invention

FIG. 19 illustrates the modifications to the Java development environment to enable co development of both hard and soft “chips”, according to an embodiment of the present invention

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

The object of this invention is a new type of processor to execute Java instructions, based on analyzing the set of Java Byte Code instructions in a Java program supplied. The byte code version of the program is “read” to determine the essential set of Java Byte Code instruction needed to be converted to hardware and supported. This type of Java processor is application specific and is generated dynamically for a specific Java program.

Analysis of Program at Byte Code Level

The dynamic and automated generation of an application specific Java Processor is possible because a list of the Java Byte Code instructions that need to be compiled into Verilog to generate the custom processor function blocks has been hand coded. The complete Java instruction set is 227 instructions. While a complete set of instructions may be a hand coded function—to produce full Java processors—the purpose of the analysis of the Java program is to reduce the number of gates needed by compiling only those needed by the program.

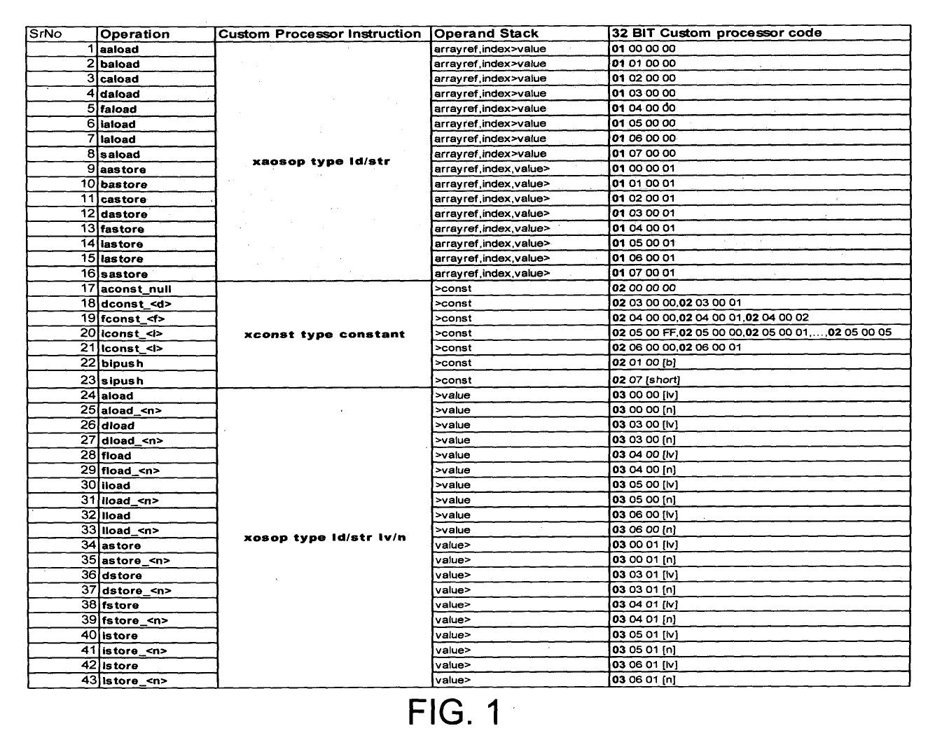

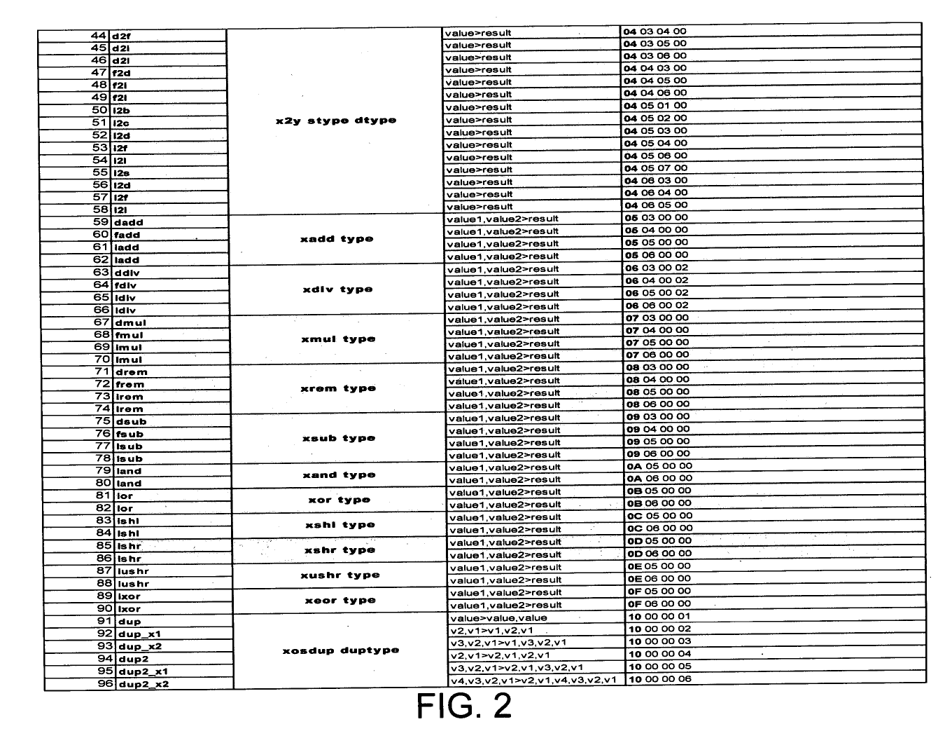

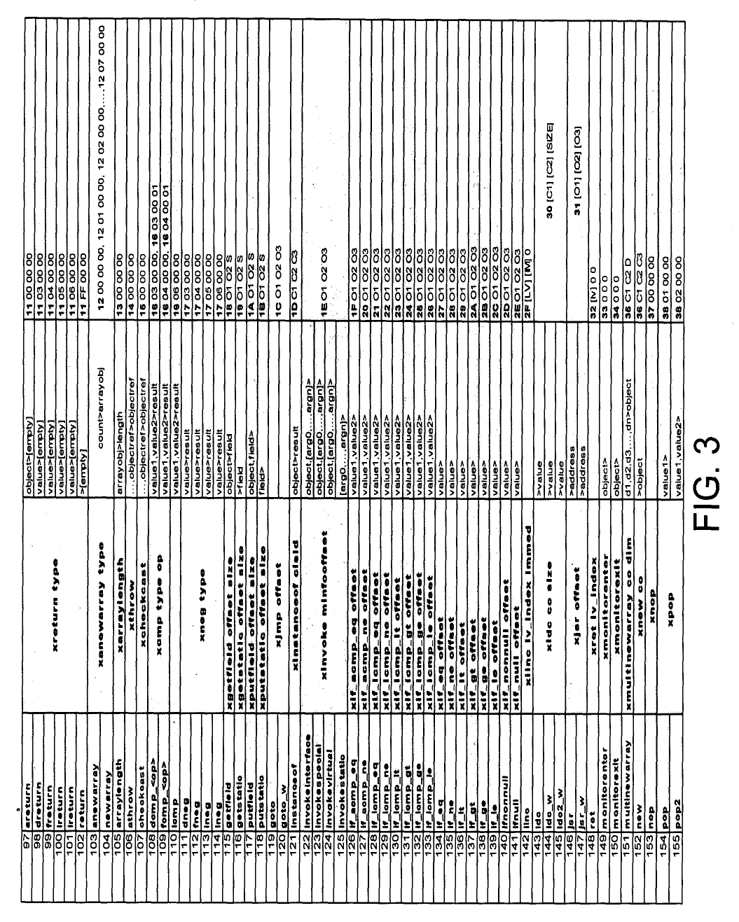

Referring to FIGS. 1, 2, and 3 for each Java Byte Code instruction, there is an equivalent 32 bit custom Processor code along the lines of Reduced Instruction Set Computing (RISC) and have been identified by a thorough analysis of all Java Byte Code instructions. This RISC instruction set, dramatically reduces the number of Algorithmic State Machine (ASM) charts needed to define the complete RISC instruction set to support all the Java Byte Codes. FIGS. 1, 2, and 3 indicate the RISC like instructions, using grouping of Java Byte Code instructions.

Grouping of the Java Byte Codes to map to a smaller set of RISC instructions reduces the size of the instruction set for the custom processor and hence also the number of gates required. Further, since the parameters list has been regularized, it is now possible to convert Java Byte Code instructions in the program to a more uniform data structure. This uniformity results in higher performance.

Further, since the entire program is available for analysis, memory for data can be separated into code and constants with specific frame stacks for operations and maintaining the state of the machine. As a result, complete support for recursion and subroutine calling is supported. It is now also possible to separate the program from the data and support separate memory controllers for different types of memory: Data heap, code, constants etc. By maintaining separate memory units, each with its own memory controller, it is now possible to convert a fetch/execute cycle involving multiple sequential data fetches to a fetch execute cycle with multiple data fetches occurring in parallel. This is possible because the memory has been segmented into multiple memory blocks each with its own memory controller, running in parallel in the fetch cycle.

Contrast this with a typical Java processor, interpreting Java Byte Code at run time, each fetch/execute step involves multiple data fetches—there is only one memory controller and one memory area. Segmentation thus reduces the number of data fetches based on the number of memory controllers and type of data being fetched.

Upon comparison of typical byte code instructions, the number of parameters being passed and the conversion to a RISC like instruction set with multiple memory controllers for Code, constants etc., the average improvement in reduction of fetch cycles was computed to be 3:1.

Further improvements in performance stem from the fact that Just In Time (JIT) like optimizations provide performance enhancements for enterprise class Java run time deployments (enterprise servers running Java byte code on a Java Virtual Machine, for example). However, embedded systems lack the resources for a JIT compiler that can optimize the indirections for a constants pool, for example.

By analysis of the program at design time, the functionality of a JIT compiler for optimization, is incorporated in, for example, optimized indirection for the constants pool. Since the Just in Time (JIT) functionality is not available in embedded systems due to resource constraints, design time analysis at byte code level of the program is an attractive means to design a high performance optimized processor for the Java program.

Generating the Custom Processor

Once the required Java Byte codes have been identified, the hand coded versions of their implementations in a Hardware Description Language (HDL) like Verilog, is added to the list of silicon circuits that need to be incorporated in the final design. These circuits represent the hardware implementations of Java Byte Code instructions.

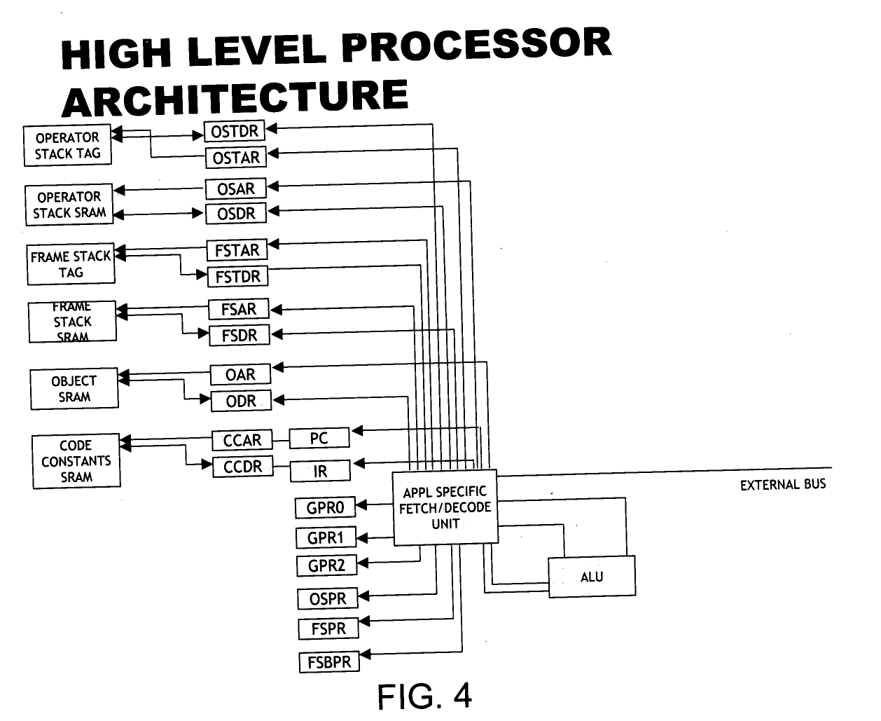

A processor, running the usual Fetch/Execute cycle now needs to be designed to read the Java program instructions and run the necessary byte code instructions. Referring to FIG. 4, a representative high level processor to perform this task is shown. OSTDR refers to the Operator Stack Tag Data Register and OSTAR to the Operator Stack Tag Address Register. Other data and address registers follow the same nomenclature. Note that there are three separate memory areas: The Frame Stack SRAM, Object SRAM and CODE CONSTANTS SRAM. By maintaining three separate memory areas, one can pipeline the Fetch/Execute instruction so each memory controller can work in parallel and parallelize the fetching of data. In the traditional processor or Java based processors, there is only one memory controller and hence this is not an option.

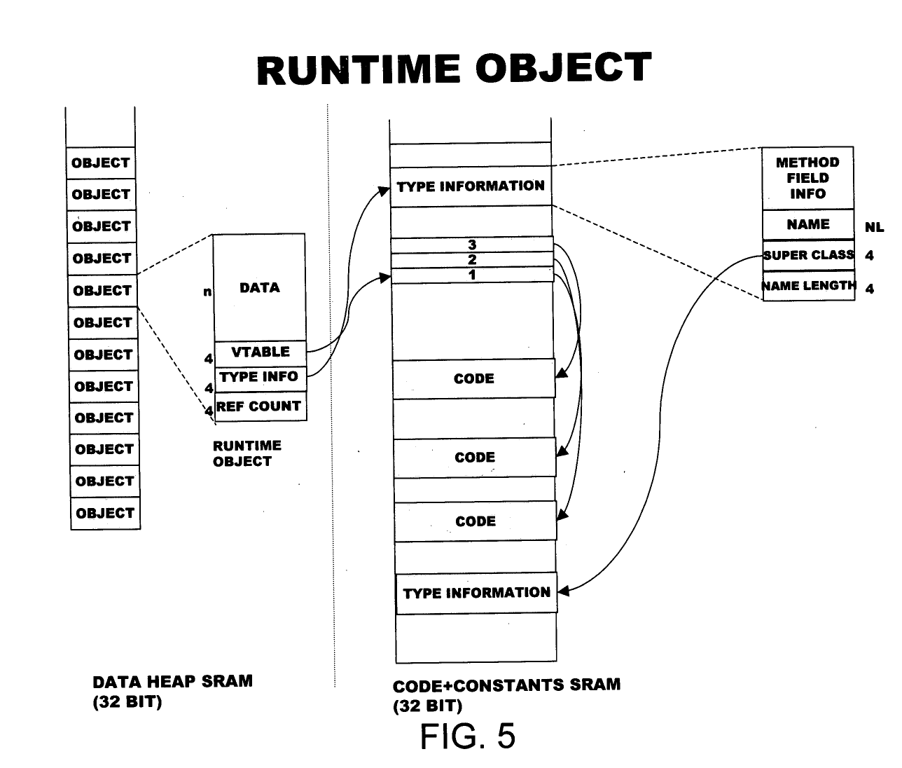

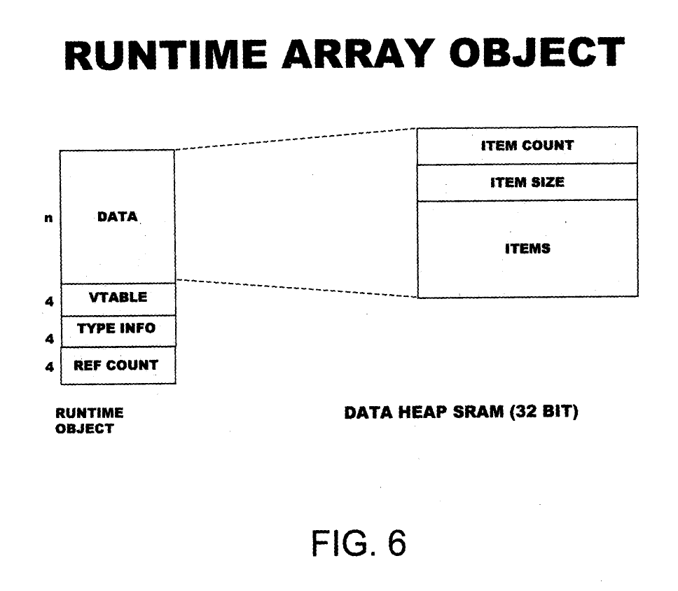

FIGS. 5 and 6 depict how run time objects are handled in memory. Recall that the Java Program under analysis will have classes and objects each of which has its own data, Vtable (symbol table space), type information and reference count (to address subroutine calls and recursion). When the program is analyzed, provisions are made to allocate the memory required for all run time objects and also, as shown in FIG. 6, an array of run time objects.

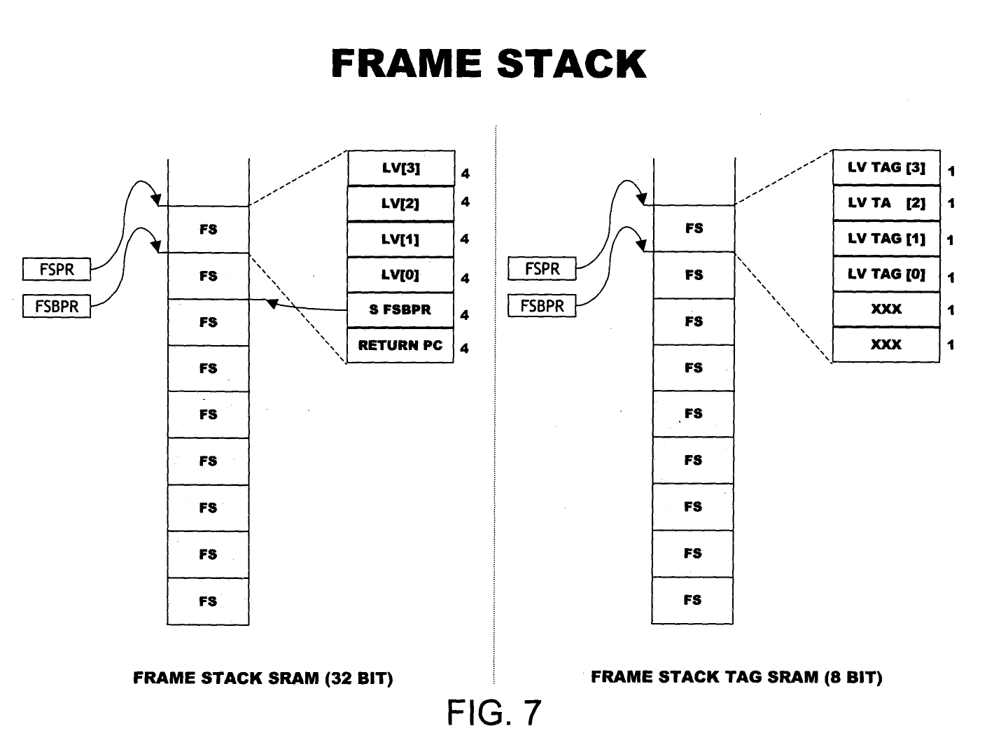

Since the Java application specific custom processor will be executing Java programs that include subroutine calls and recursion, the processor has to maintain a frame stack and pointers to the current program being called. Referring to FIG. 7, each frame stack has to maintain the Frame Stack Pointer (FSPR) and the Frame Stack Base Pointer (FSBPR) needed to return control to the calling program, two versions, for 32 bit and 8 bit are shown.

Building the Algorithmic State Machine Charts and Code Blocks

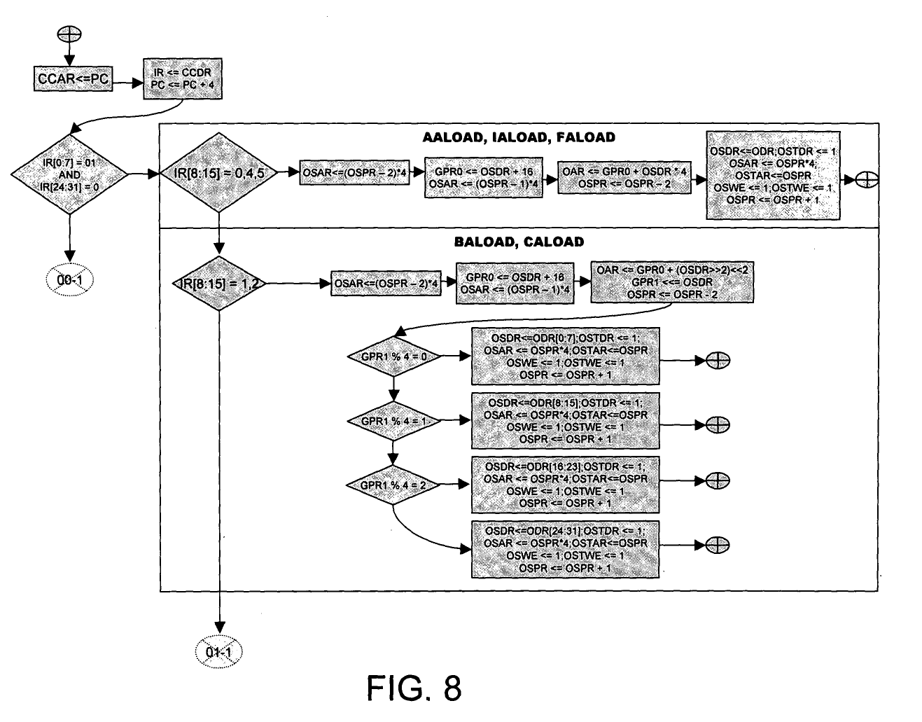

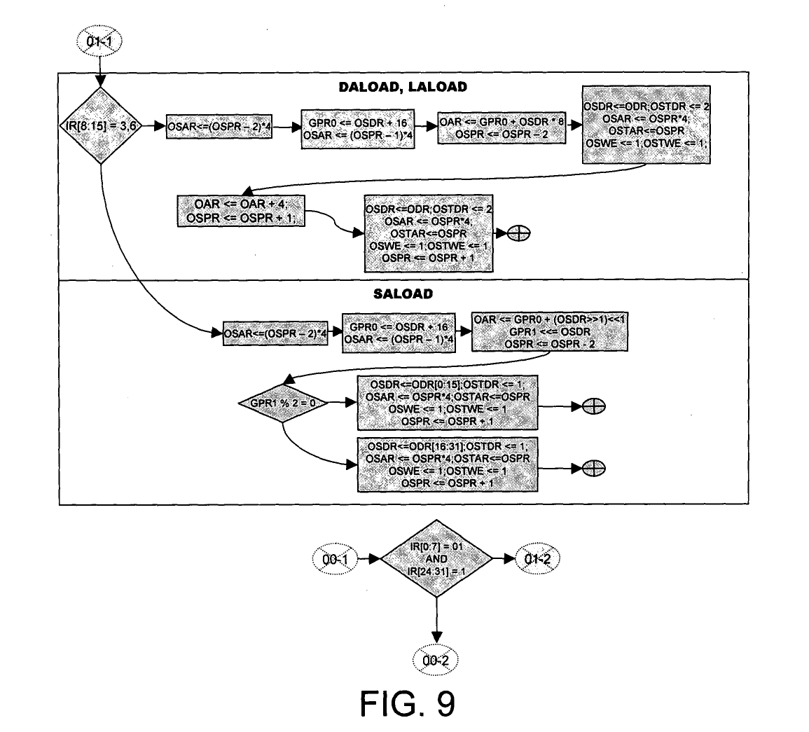

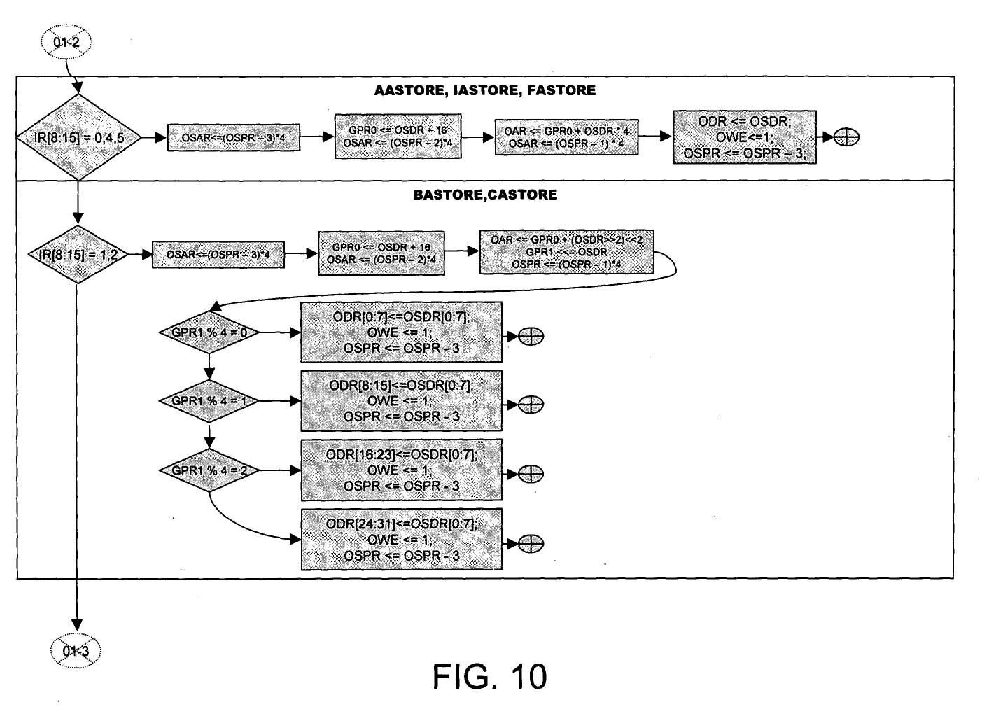

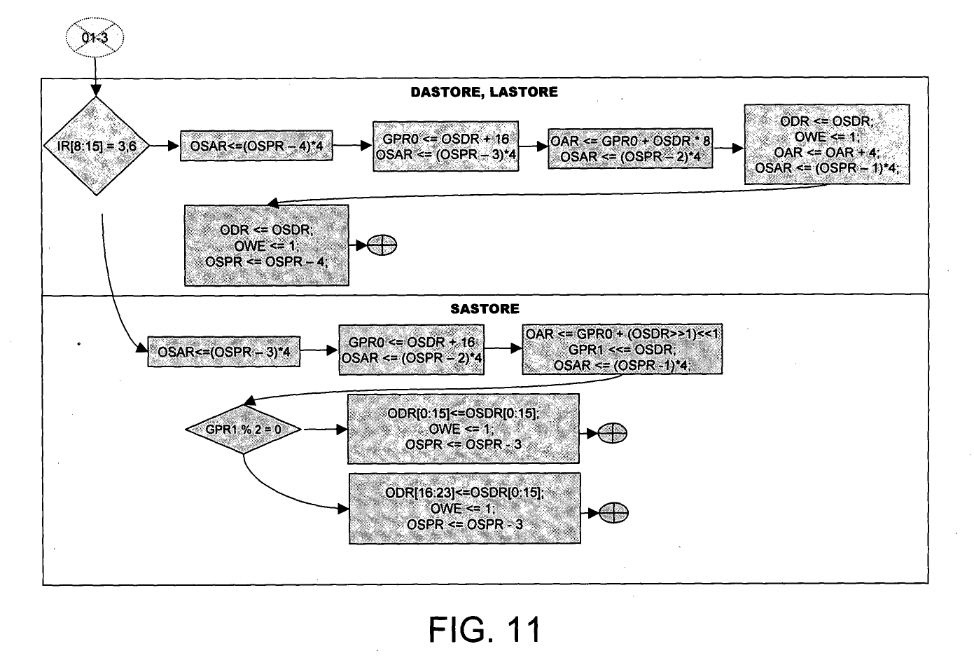

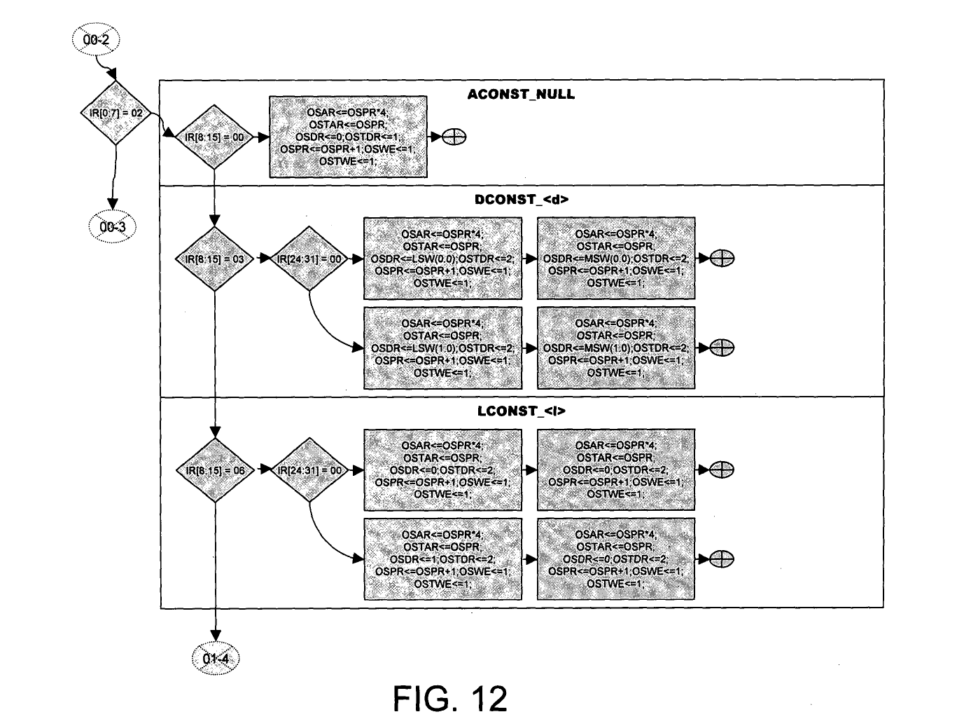

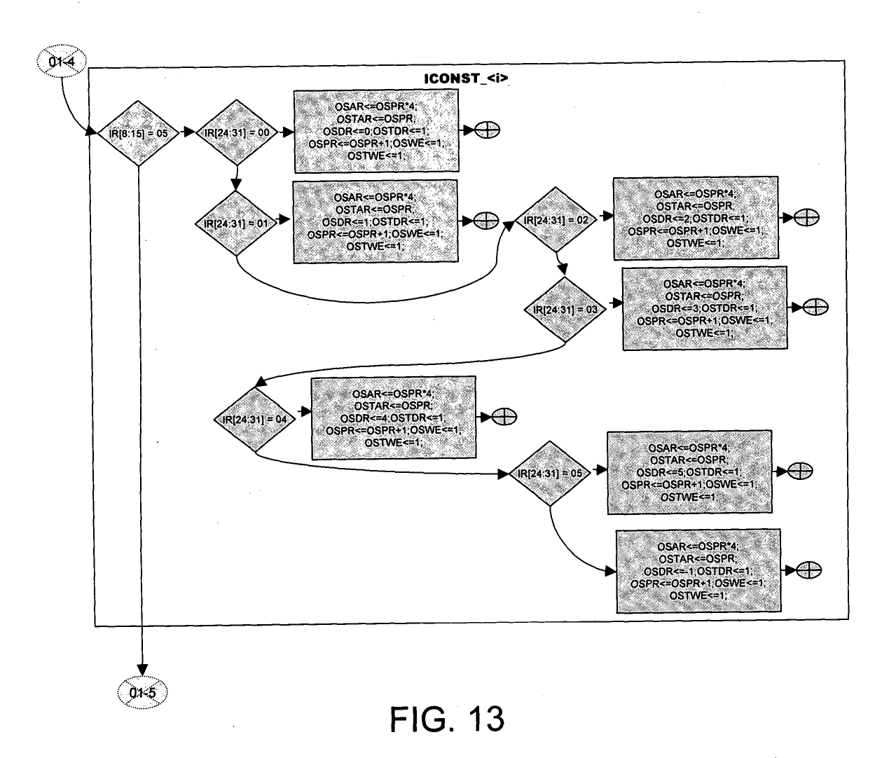

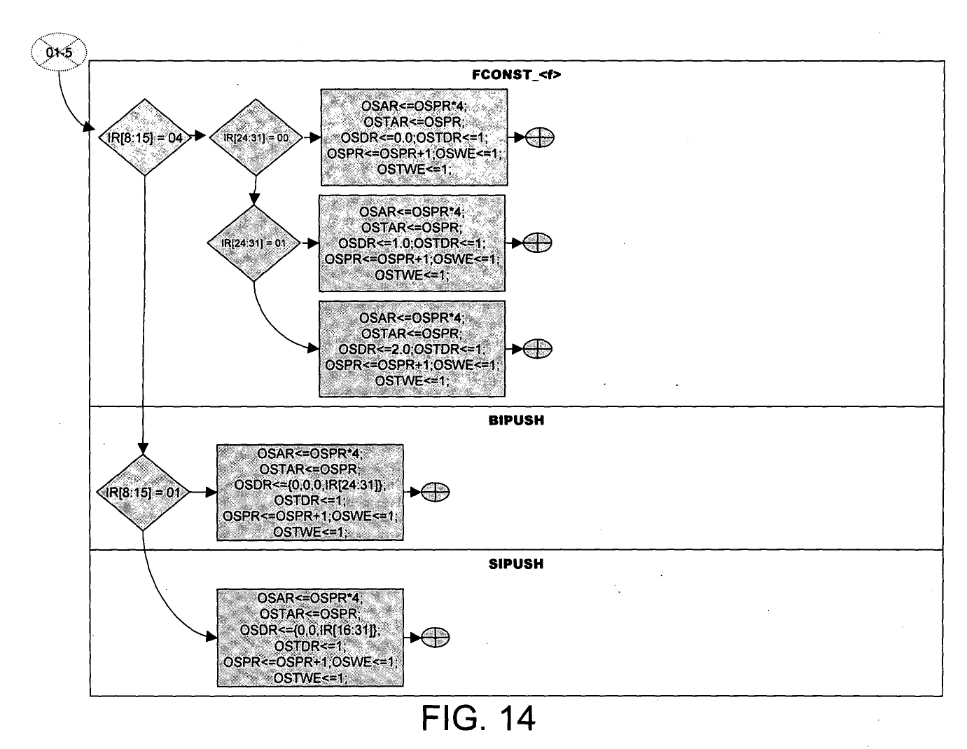

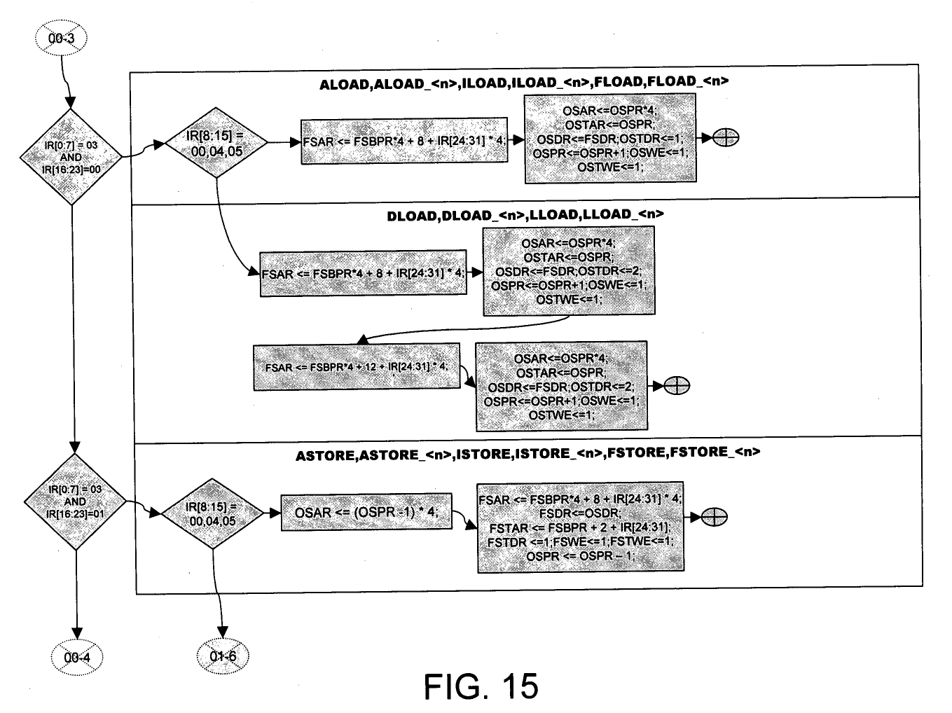

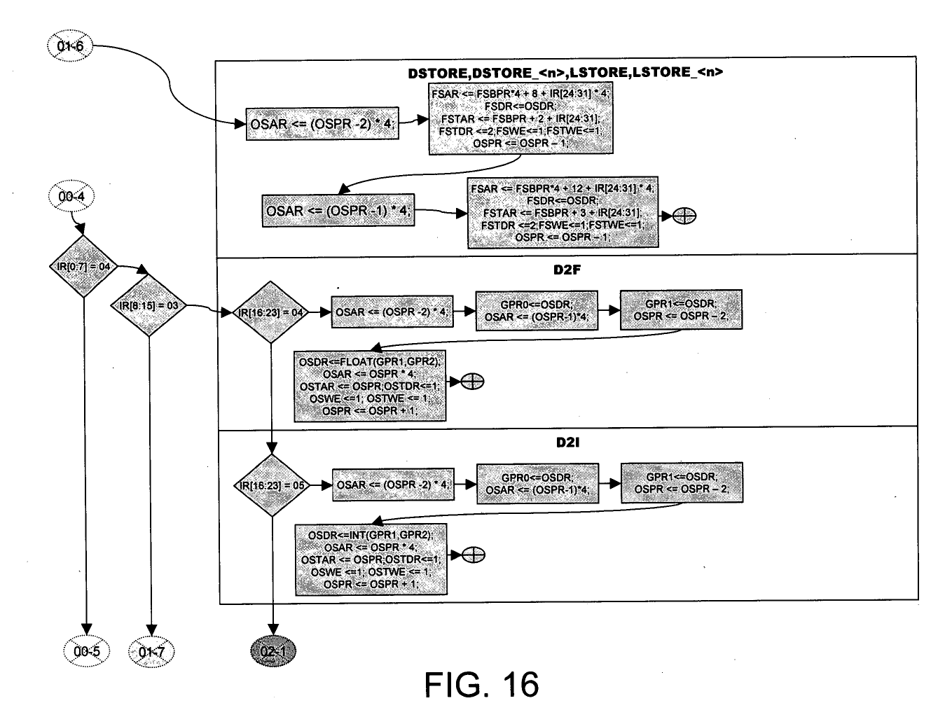

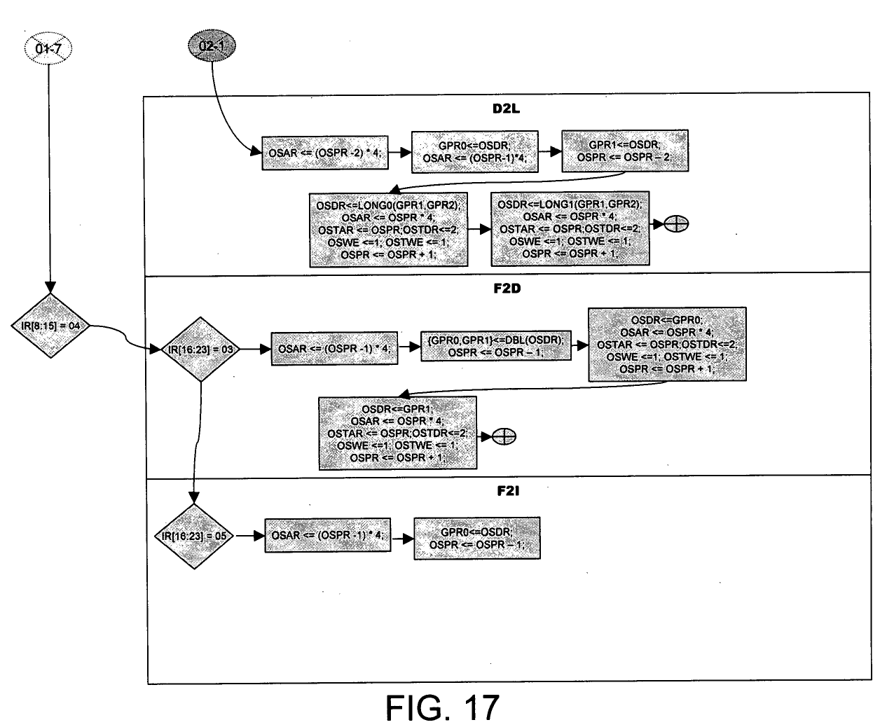

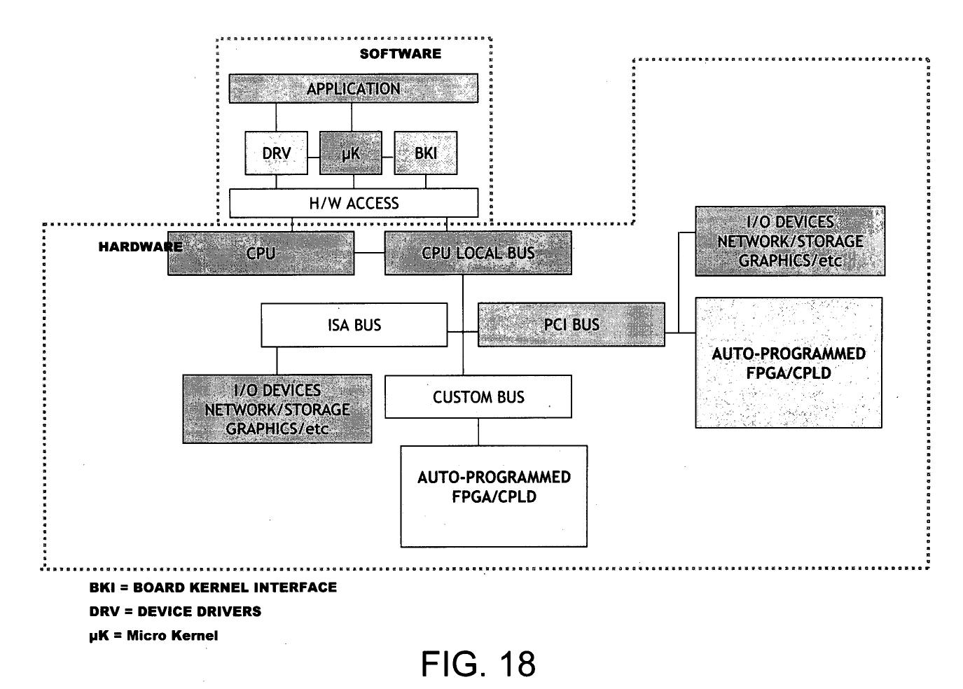

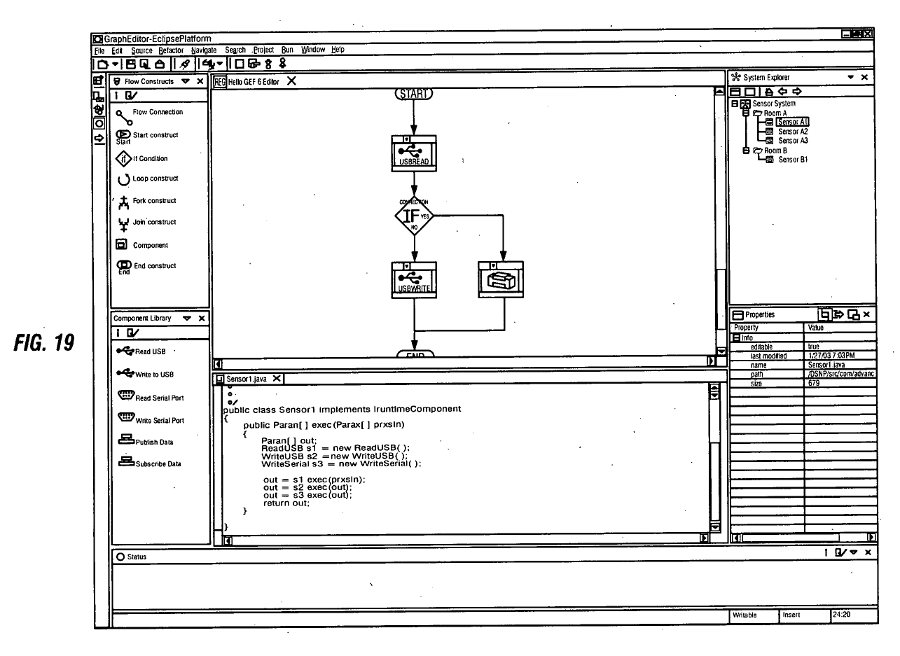

FIGS. 8 through 17 show some of the Algorithmic State Machine (ASM) charts developed for hand coding the Java byte instructions to Verilog code blocks for inclusion into the custom processor hardware module. On completion of the Verilog code, a test system, shown in FIG. 18, is used to test whether the Java Byte Code is performing correctly in the FPGA. Finally this test unit becomes part of a prototyping environment integrated with the flow graph simulation system described in the previously referenced patent application and shown also in FIG. 19.

Applicability beyond Java

The method outlined above is not limited to Java or the analysis of Java Byte Code, and is one embodiment of this invention. The method of analysis of Java Byte Code is essentially a method of analysis of a program written in any language, after which it is compiled for a target processor, in this case the Java Virtual Machine. However the approach described is not limited to Java. A program in C, for example, may be converted to Java, using commercially available Java translators, and then the current embodiment of this invention is directly applicable.

Alternately, the approach to building custom processors for other languages—without conversion to Java—is to build a target compiler for a Virtual Machine for which the instructions have been generated, in much the same manner as shown above. Since a custom processor based on Reduced Instruction Set Computing (RISC) has been developed, one approach could be to generate a compiler for that target processor, using the same methodology described above for one language, Java.

Hardware-Software Co Design and Development Environment

This extension to the referenced patent application describes further enhancements to the implementation of the algorithms in hardware. In the referenced patent application, a method to reduce the software footprint was described, employing a method by which a self standing small footprint executable was produced by analyzing Java application code at the byte code level. On analysis, a method to identify components of the Operating System that were needed to run the application was described. Including only those portions of the Operating System services that were essential to the application resulted in a low footprint executable that could run on lower cost microprocessors. The approach was described as the Application Specific Operating System (ASOS) and removed the OS and Java Virtual Machine (JVM) requirements from Java programs.

The ASOS Approach did require the need for a general-purpose microprocessor to run the self sufficient code so generated. This is referred to as a “soft” chip since while it is software (and hence soft) it has some of the encapsulation qualities of a semiconductor chip. Further, the deployment is software code resident in memory and executed by a processor.

Further reducing the cost of power and chip count of an embedded system can be achieved by reducing the need for a general-purpose microprocessor and its associated overhead. In cases where the program is relatively simple and running on 1 or 2 threads, an approach was described where the generation of Application Specific processors are automated through analysis of the Byte Code instructions in the program.

This is referred to as a “Hard” chip since while Verilog “code” is being degenerated, the deployment is a self sufficient semiconductor chip, with no dependencies on an external processor for the normal functioning of the program.

Starting from the same code base in Java, the “soft” and “hard” chip approaches, both based on analysis of Java Byte Code, present two deployment vehicles within the same development environment. Further, as shown in FIG. 19, portions of the code can be split up so both hard and soft implementations may be generated based on the type of conversion needed. A co-development and co-design framework is thus available to generate both “hard”, “soft” or any variation of “soft” and “hard”, all within one development environment and one programming language.

Further, since the generation of both “soft” and “hard” chips occurs through analysis of Java Byte Code, no access to Java Source code is needed. This ensures that intellectual property inherent in the source code of the program, does not have to be divulged, for the generation of “soft” or “hard” types of chips described.

Co Design and Development Environment

Based on the two types of an analysis of programs at the Byte code Level, a co-development framework for low cost embedded system development is being built that eliminates dependencies and licensing costs of an OS, JVM and, in many cases, processor cores. The product is integrated into a open Java based development environment (IBM's Eclipse) and supports:

OS Stack-Less C code Executable creation based on Soft Chips approach. Java byte code is analyzed and a low footprint self-standing C code is created, with essential services required by the application fused with it. It eliminates the overhead/licensing of an OS/JVM for Embedded Java apps. It enables the use of lower cost and lower power 8/16 bit microprocessors.

Processor-Less Verilog “code” creation. This is a Java—FPGA/ASIC conversion tool analyses Java byte code to automatically create a customized co-processor to process the Java Byte code of the application. Both the application byte code and required co-processor are converted to a Verilog file for FPGA/ASIC creation, resulting in a high performance, low power compact module. It enables the use of lower cost and lower power 8/16 bit microprocessors. In many applications, it eliminates the need and associated costs for a general-purpose processor.

Representative Applications of Co-Development Environment

The ability to generate both hard and soft chips within one development environment was initially designed and developed for wireless enabled sensor networks where sensor modules, running relatively simple programs could be remotely programmed to perform routine sensing and send alarms in the event sensor readings were not within prescribed bounds.

The program could be uploaded to the sensor module in one of two forms: software for an embedded system processor or as a circuit, complete with a custom processor, for download to a Field Programmable Gate Array (FPGA) in the field. Since the co-development environment supports both deployment vehicles, a comprehensive approach to designing simple embedded devices is available for applications other than wireless sensor networks.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

What is claimed is:

1. A method for a dynamic and automated generation of a custom processor for a Java program comprising steps of:
a) analyzing the Java program at a byte code level to determine an essential instruction set;
b) converting the essential instruction set to a smaller, more regular Reduced Instruction Set Computing (RISC) instruction set;
c) segmenting memory into code, constants and run time pools with a plurality of separate memory controllers for higher performance in a fetch/execute cycle;
c) supporting subroutine calls and recursion through management of a plurality of frame stack pointers;
d) coding of the essential instruction set based on a plurality of Algorithmic State Machine (ASM) charts; and
e) testing and deploying a system that enables Java code to be directly converted to hardware.

2. The method according to claim 1 wherein the step of analyzing requires no access to source code during conversion and operates strictly on a code intended for a Java Virtual Machine, thereby distinct from Java Compilers or other approaches operating at a source code level requiring access to the source code and associated intellectual property.

3. The method according to claim 1 wherein the step of analyzing may be applied to programs written in other languages and subsequently converted to Java Byte Code either by automatically converting the code to Java or compiling it for a RISC like processor.

4. The method according to claim 1 wherein the step of analyzing results in the generation of a custom processor to run the algorithm, thereby removing the need for a generic purpose processor, resulting in decreased cost, power requirements and more compact devices.

5. The method according to claim 1 wherein the step of analyzing is extended to include all 227 byte code instructions of the Java Virtual Machine, resulting in a general purpose Java processor, which is more optimized than current Java processors.

6. The method according to claim 1 further comprising step of:
generating application specific and low footprint software for embedded system processors;
wherein the low footprint, is generated as a result of a library of components of a plurality of operating system services with which a plurality of self standing executables is generated to include only components of an operating system essential for an operation of an application; and
whereby a comprehensive hardware-software co-development environment is formed, operating in one framework with one common high level language and one common code base, thereby enabling a rapid migration from low footprint code generated for embedded system processors to a hardware implementation of the software, with a custom processor generated for the code.

7. The method according to claim 6 wherein the analyzing step requires no access to source code and thereby protects intellectual property associated with the source code.

8. The method according to claim 1 wherein the analyzing step further comprises generating code to run on a multitude of devices, including low cost, resource limited hardware.

9. The method according to claim 1 wherein the analyzing step further comprises generating code to run on devices such as Field Programmable Gate Arrays (FPGA) that can be upgraded in the field, remotely, via the Internet.
